(19) United States
(12) Patent Application Publication
(10) Pub. No.: US 2010/0088902 A1
(43) Pub. Date: Apr. 15, 2010

(54) Handheld lawn tool

(76) Inventor: Edward Patrick Hurley, Sarasota, FL (US)

Correspondence Address: Maxey Law Offices, PLLC, 13630 58TH ST. NORTH, SUITE 101, CLEARWATER, FL, 33760, US

(21) Appl. No.: 12/319,328

(22) Filed: Jan. 6, 2009

Related U.S. Application Data
(63) Continuation of application No. 12/287,548, filed on Oct. 10, 2008.

(51) Int. Cl. A01D 34/416; A01D 34/62

(52) U.S. Cl. 30/275.4; 30/276; 30/277.4; 30/286; 30/312

(57) ABSTRACT

A handheld lawn tool including a first arm and a second arm, a third arm horizontally on the first arm and a forth arm pivotally on the second arm, an operator applying a functional grip on a first control grip over the third arm and on a second control grip along a first forward transport path in a horizontal cutting circle of a cutting tool, a reverse hand grasp on the second control grip for transposing the second grip into a third control grip with the boom arranged in a diagonal direction, the first functional hand grasp on the first control grip plus the second functional hand grasp on the third control grip with a vertical cutting circle of the cutting tool in a second transport path, the balancing point of the boom transposing between the transport path.

### CROSS REFERENCE TO RELATED APPLICATIONS

This is a continuation in part of Ser. No. 12/287,548, filed on Oct. 10, 2008.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of grounds maintenance and more specifically to a handheld lawn tool.

It is known in the art that the US consumes about forty percent of all handheld powered line trimmers on a global scale. In this case, the soft line trimmer material on the front end of the boom is outstretched more than a rear arm of the boom in relation to the boom's center of gravity. Outstretched line trimmer arms are primarily focused at or near the lawn point of contact for producing less work, but these support arms could also damage innocent objects after become high speed levers from hard impact grounds resistance. Accordingly, the high volume of handheld powered line trimmer sales in America shows that millions of US workers can be subjected to high amounts of grounds resistance from hard objects; such as, fences or sidewalks, in conjunction with grooming lawns. One can further estimate that tens, if not hundreds, of millions of dollars in energy could be annually wasted from unnecessary bending of line trimmer material.

Grounds disturbances can trigger back towards the operator based on where the line trimmer is held and how leverage of the line filament is arranged. Indeed, softer line filament may be preferred for line trimmers over resin filled line filament for self regulation and stoppage of portable line trimmer operations under high grounds resistance conditions even though handheld power tool breakdowns are a hassle. Soft line filament material has a lower heat tolerance than metal resin line filament products and will usually seize or break sooner. Hence, the softer line filament material is ideally suited for inexperienced landscapers for training them how to avoid high resistance.

The location of many rearward longitudinal control grips on portable line trimmers will sometimes vibrate about fifteen percent greater than the forward handle because of high speed pivotal line filament sometimes wanting to bend in a radian pattern of high resistance followed by corrective response which causes repetitive pumping motions similar to the hand pumping of a water well arm. In the repeated attempt of the line filament to bounce back to normal the line filament disturbances generally translate about fifteen percent more up the distance of the longitudinal arm of handheld lawn trimmers with respect to forward handles being arranged about fifteen percent closer to the line filament outermost cutting circle.

A bicycle handle including a left grip and a right grip can be arranged on the longitudinal shaft for minimizing impact response of line filament pumping action, as shown in U.S. Pat. No. 6,901,666 ('66). However, the structural arrangement of ('66) offers minimal longitudinal support along landscape slopes when falls occur. The difficulty in interchanging the bicycle handle of '66 could likely discourage its use between lawn grooming and brush cutting exercises. The '66 invention is costly to produce when considering its limited commercial use, yet it remains an important lever device for bladed brush cutting work.

The '66 invention, as shown in FIG. 1 of '66, can be turned in a right angle to the left for viewing how a horizontally designed portable line trimmer could possibly be misused. A vertically arrangement of US Pat. '66 would unmistakably force the motor near breathing passages of an operator and the line filament could easily bend on hard pavement because the operator must hand grasp a rearward longitudinal portion of the boom while hand grasping the trigger control in a difficult contortion. The vertically arranged shield of '66 also hides the working front end of the line filament.

Commercial landscapers, with annual incomes in the twenty-seven thousand dollar range, may earn up to about six thousand dollars in additional salary simply by folding their lawn tools between a horizontal lawn trimming arrangement and a vertical lawn trimming arrangement. However, we now know that important safety measures must be at least explained to the landscapers for avoiding hours of missed work caused by high resistance fatigue wounds and unnecessary trimming practices that wastes energy. The deflected energy may produce greater thrust of projectiles for increasing risks of injury. Landscapers should be aware of how to hold handheld lawn trimmer in accurate angles for symmetrical wear of weak line filament material. But, oblique arranged line trimmers will wear line filament material asymmetrically on the lower edge when subjected to mostly horizontal hard surfaces which operatively adds repeated disturbances towards the operator. Line trimmers must also have vertical cutting angle limits put in place for preventing the trailing cutting guard radian from obstructing the operator's leading radial view of the operable line filament material. An accurate vertical lawn trimming angle lock also allows the upper line filament edge to wear evenly on the line trimmer. Furthermore, the outer tip of line filament must be limited from bending in the lead direction of operable line filament material for limiting heat buildup and for eliminating expansion of lubricated drive components on handheld powered line trimmers. A lightweight wheel similar to a wheel described in U.S. Pat. No. 4,995,487 is ideal for leveraging line filament outer tip responses to resistance. In fact, a lightweight wheel suspension and proper trimming angle permits flexible line filament to symmetrically wear on the handheld trimmer described in US Pat. 2007/0197128 A1 ('28), but the distal end of the '28 handle will produce greater response from hard impact which is why the '66 bicycle handle is preferably centered in a lateral arrangement near the proximal end of the '66 control device in the lawn trimmer or brush cutting operations.

Today, there doesn't appear to be a portable line trimmer in production that will keep grounds resistance response to a minimum near ground level and away from the operator between a horizontal lawn trimming angle and an abutting vertical lawn trimming angle which is the purpose of this patent application.

### BRIEF SUMMARY OF THE INVENTION

The primary object of the invention is to provide a handheld lawn tool in an accurate operating angle for greater symmetrical wear on the cutting tool.

Another object of the invention is to provide the handheld lawn tool with a time saving operation in front of the operator for less energy consumption.

Yet another object of the invention is to provide the handheld lawn tool with ergonomic grips for adding comfort to the functional hand grasps of the operator.

A further object of the invention is to provide the handheld lawn tool with about minimum lateral resistance response potential.

Still yet another object of the invention is to provide the handheld lawn tool with about minimum longitudinal resistance response potential.

One more object of the invention is to provide the handheld lawn tool with about minimum vertical resistance response potential.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a handheld lawn tool comprising: a motor assembly including a source of power horizontally fixed on a first arm for transferring energy to a motor, the motor operatively transferring the energy axially down a drive shaft within at least a second arm to a pivotally fixed arrangement of a tool assembly for lawn grooming, the tool assembly including a blower for assisting a substantial leading radian portion of a cutting tool, wherein a trailing radian portion of the cutting tool is covered by a cutting guard substantially in front of an operator, a front distal end of the second arm mounted to the tool assembly and a rear distal end of the second arm mounted to the first arm for forming a longitudinal arrangement of a boom, a first bracket fixed to the first arm and a second bracket fixed to the second arm, a third arm having a proximal end horizontally fixed to the first bracket in about pivotal alignment of a forth arm, the forth arm fixed at a proximal end to the second bracket for a substantial lateral arrangement of the boom, a first control grip horizontally fixed over a distal end of the third arm, the first control grip including an on/off switch pivotally arranged for activating and deactivating the motor and a trigger control pivotally arranged on the first control grip for activating and deactivating the cutting tool, an operator having means for applying a functionally hand grasp on the first control grip in an inoperative arrangement of the cutting tool, the operator having means for applying a functional grip on the trigger control and the first control grip in an operative arrangement of the cutting tool, a second control grip fixed over a distal end of the forth arm in about lateral alignment of the first control grip for a lateral arrangement of the boom, the operator having means for applying a second functional hand grasp on the second control grip in a first forward transport path of the boom with the cutting tool circumferentially locked in the horizontal cutting circle of the cutting tool about two inches above the ground level in front of the operator, a reverse hand grasp of the operator is applied on the second control grip for transposing the second control grip arrangement into a third control grip arrangement, the forth arm pivots and transposes the second control grip arrangement into the third grip arrangement through the axis of the first arm away from the second arm and the tool assembly, the transposing of the second control grip into the third control grip rearranges the distal ends of the first and the second arms in a first diagonal direction with the third and the forth arms diagonally rearranged for the first and the second functional hand grasps of the operator, the operator having means for applying the first functional hand grasp on the first control grip and the trigger control with the second functional hand grasp on the third control grip with the cutting tool circumferentially locked in the vertical cutting circle substantially along the ground level in the second forward transport path in which the operator transports the handheld lawn tool along the first forward transport path, the balancing point of the boom transposing between the first forward transport path of the horizontal cutting circle of the cutting circle and the second forward transport path of the abutting vertical cutting circle of the cutting tool, the first arm having means for interchanging on an opposite side of the boom in which the first functional hand grasp of the operator arranged on the second control grip and the second functional hand grasp of the operator arranged on the first control grip in the horizontal cutting circle arrangement of the cutting circle, the operator having means for negative transposing the second control grip into the third control grip in which the vertical cutting circle arranged in a third forward transport path mirroring the second forward transport path in an opposite direction of the vertical cutting circle of the cutting tool, the first bracket having means for at least a first gear longitudinally arranged within the first bracket with the first gear cylindrically connected to the boom where the boom having splitting means and the second bracket having means for at least a second gear laterally arranged within the second bracket with the second gear fixed to the third arm and pivotally connected to the first gear.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1a is a perspective view illustrating the handheld lawn tool aligned in a straight longitudinal arrangement of a boom for the operator to functionally hand grasp the lateral arrangement of the boom in the horizontal arrangement of the tool assembly.

FIG. 1b is a perspective view of FIG. 1 illustrating a larger tool assembly and a lighter bow shaped arrangement of the boom embodiment of the invention.

FIG. 2 is a perspective view of FIG. 1 illustrating the operator's left hand in a hook grasp on the second control grip for pulling the forth arm rearward into the third grip arrangement of the forth arm.

FIG. 3 is a perspective right view of FIG. 1 illustrating the first control grip remaining in the horizontal arrangement after the second control grip is transposed in the third control grip arrangement for the vertical arrangement of the tool assembly and the functional hand grasp of the operator.

FIG. 4 is a side partial exploded view of FIG. 1 illustrating the first and the second control grips in a gear embodiment of the invention for providing the operator with easy integral cooperation of the first, the second, the third and the forth arms.

FIG. 5 is a side partial exploded view of FIG. 3 illustrating the third and the second control grips arranged in the gear embodiment of the invention for the operator to functionally hand grasp.

FIG. 6a is a side view of FIG. 4 illustrating the interchange of the first and the second arms embodiment of the invention for the operator to functionally hand grasp the handheld lawn tool on the opposite side of the boom.

FIG. 6b is a perspective view of FIG. 1b illustrating the first control grip being rearranged in the third arm and the third arm rearranged in the second bracket for arranging the horizontal cutting circle of the cutting tool embodiment of the invention and a hidden perspective view of the the second control grip showing the second control grip rearranged into the third control grip arrangement on the first arm for rearranging the horizontal cutting circle of the cutting tool in the other parallel vertical cutting circle embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

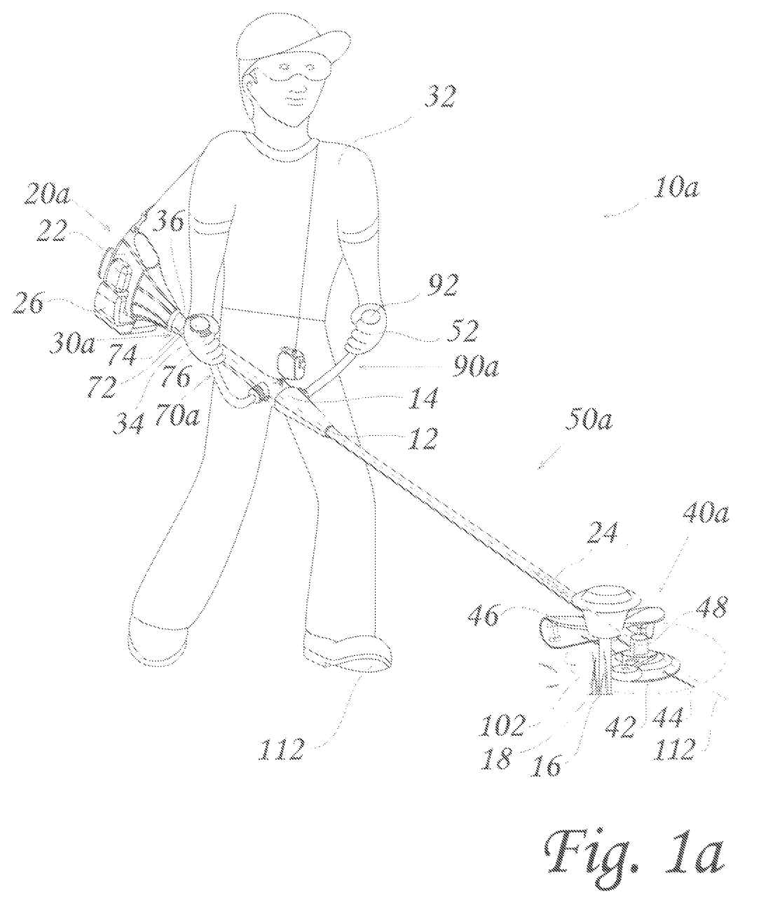

Referring to FIG. 1a-FIG. 1b, a handheld lawn tool 10a is shown comprising a motor assembly 20a that is including a source of power 26 being horizontally fixed on a first arm 30a for transferring energy to a motor 22 for lawn grooming purposes. A drive shaft 24 has means for axially extending the motor 22 within the first arm 30a and a second arm 50a to a pivotally fixed arrangement of a tool assembly 40a, but the motor 22 and the drive shaft 24 can extend only through the second arm 50a (not shown) according to sound engineering judgment. The tool assembly 40a is including a cutting guard 46 for covering a trailing radian portion of a cutting tool 42 and a blower 48 arranged substantially in front of an operator 32. A front distal end of the second arm 50a is mounted to the tool assembly 40a and a rear proximal end of the second arm 50a is mounted to a proximal end of the first arm 30a for forming a longitudinal arrangement of a boom 12. A first bracket 36 is horizontally fixed to the first arm 30a in cooperation with a second bracket 56 that is pivotally fixed to the second arm 30a. A proximal end of a third arm 70a is horizontally fixed to the first bracket 36 of the first arm 30a in about pivotal alignment of a forth arm 90a whereby a proximal end of the forth arm 90a is arranged on the second bracket 56 for having a lateral arrangement of the boom 12.

Still referring to FIG. 1a-FIG. 1b, the first and the second arms 30a and 50a are cylindrically made of a rigid steel or fabricated of a moderately rigid aluminum alloy arrangement, but the first and the second arms 30a and 50a can also be made of a combination of steel and aluminum or the like rigid material for provided a lightweight and rigid bond of the first and the second brackets 36 and 56 to the first and the second arms 30a and 50a, respectively. The composite material of the first and the second brackets 36 and 56 is preferably a plastic substance having break resistant, high bonding and operable dampening qualities. Consequently, the third and the forth arms 70a and 90a are preferably made of rigid tubular steel whenever they are laterally connected to the plastic first and second brackets 36 and 56. However, the first and the second brackets 36 and 56 can be partially made of metallic alloy whenever the third and forth arms 70a and 90a use plastic for overlapping a significant portion of the first and the second arms 30a and 50a (not shown). The second arm 50a will be bowed, as described in FIG. 1b, when the blower 48 covers a substantial portion of a leading radian working end of the cutting tool 42, but the second arm 50a can be bowed or straight when the blower 48 is small enough for the leading radian working end of the cutting tool 42 to be observed by the operator. It is important to note that a plurality of longitudinal and lateral clamping techniques of the arms 30a, 50a, 70a and 90a and the brackets 36 and 56 may be implemented according to sound engineering judgment, but it may be unsafe to match plastic joints with plastic arms because the third arm 70a and the forth arm 90a are substantially fast torque levers for rearranging the first arm 30a and the second arm 50a which could cause slippage of the boom 12 members. Both the third arm 70a and the forth arm 90a will height adjust towards the first arm 30a which is also convenient for stowing the handheld lawn tool 10a on a rack (not shown.)

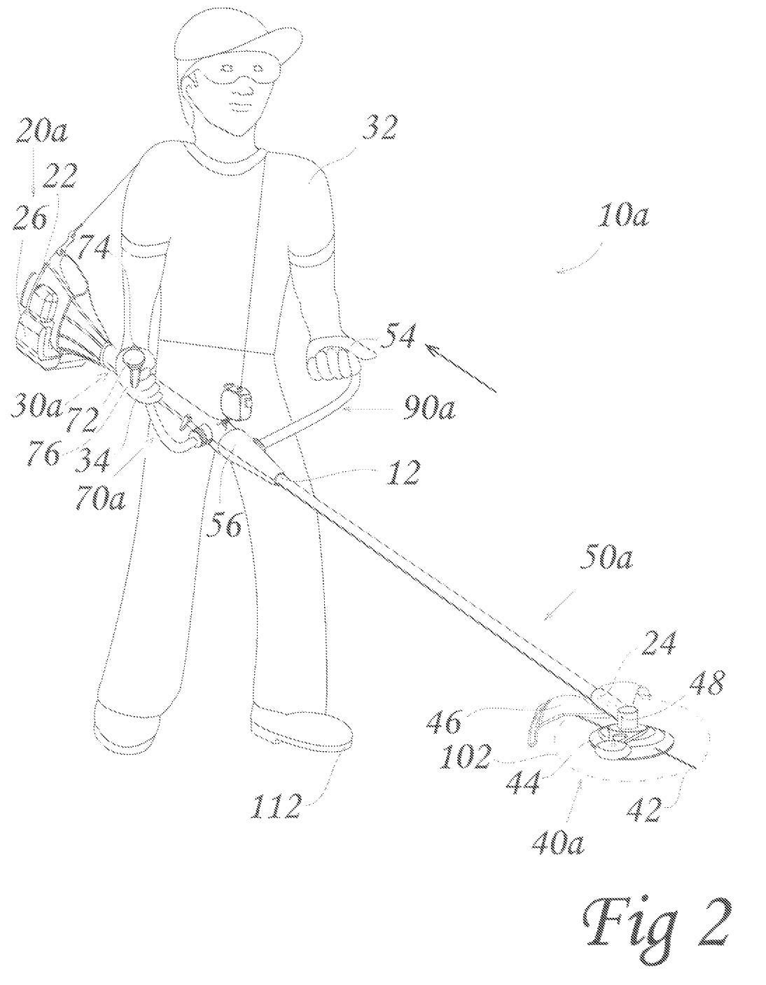

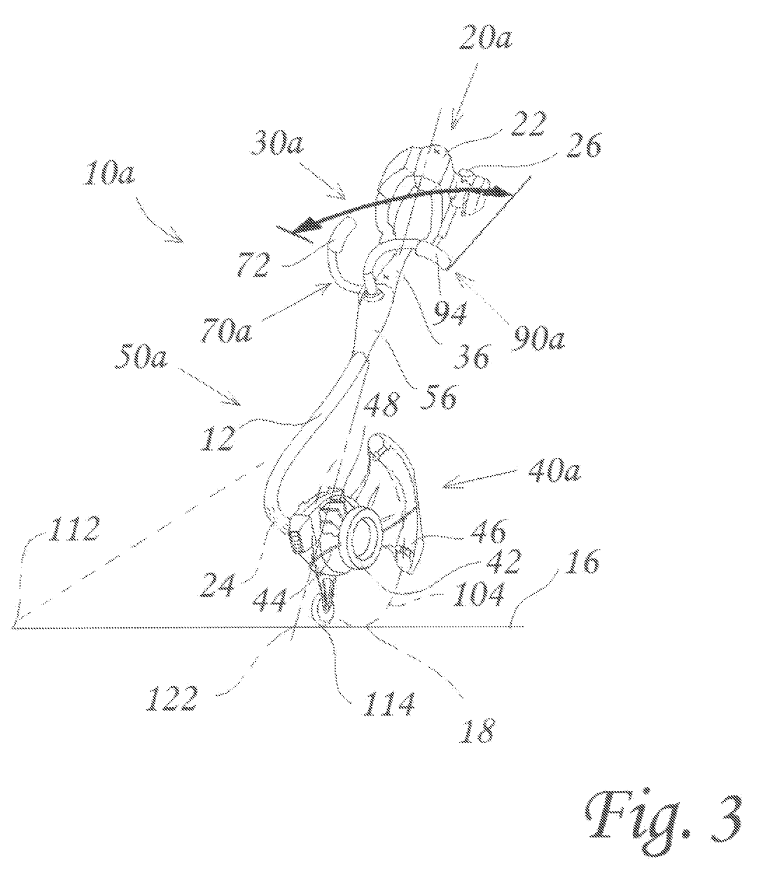

Referring to FIG. 1a-FIG. 3, a first control grip 72 is fixed over a distal end of the third arm 70a. The first control grip 72 is preferably including an on/off switch 74 which is pivotally pressed by the operator 32 for activating and deactivating power of the motor 22, but the on/off switch 74 can also be activated and deactivated on a track and the on/off switch 74 can be arranged elsewhere on the first and third arms 30a and 70a (not shown). The operator 32 has means for applying a first functional hand grasp 34 on the first control grip 92 off the trigger control 76 during proceeding pivotal adjustments of the second arm 50a and the tool assembly 40a in an inoperative arrangement of the cutting tool 42, as appreciated in FIG. 2. A second control grip 92 is fixed over a distal end of the forth arm 90a along a first forward transport path 112 of the boom 12 with the cutting tool 42 circumferentially arranged in a horizontal cutting circle 102 of the cutting tool 42 in a lateral pivot motion about two inches above the ground level in front of the operator 32. The third and the forth arms 70a and 90a are preferably adjusted and locked into a prearranged orthogonal place on the boom 12 in congruent relation of the horizontal cutting circle 102 arrangement of the cutting tool 42, as viewed in FIG. 2, and an abutting vertical cutting circle 104 arrangement of the cutting tool 42, as described in FIG. 3, prior to the handheld lawn tool 10a being operated. The abutting horizontal and vertical arrangements of the tool assembly 40a are primarily used for arranging the cutting tool 42 only between a positive or a negative orthogonal isometry substantially in front of the operator. The positive and negative orthogonal arrangement of the cutting tool 44 permits the line filament 42 material to wear uniformly.

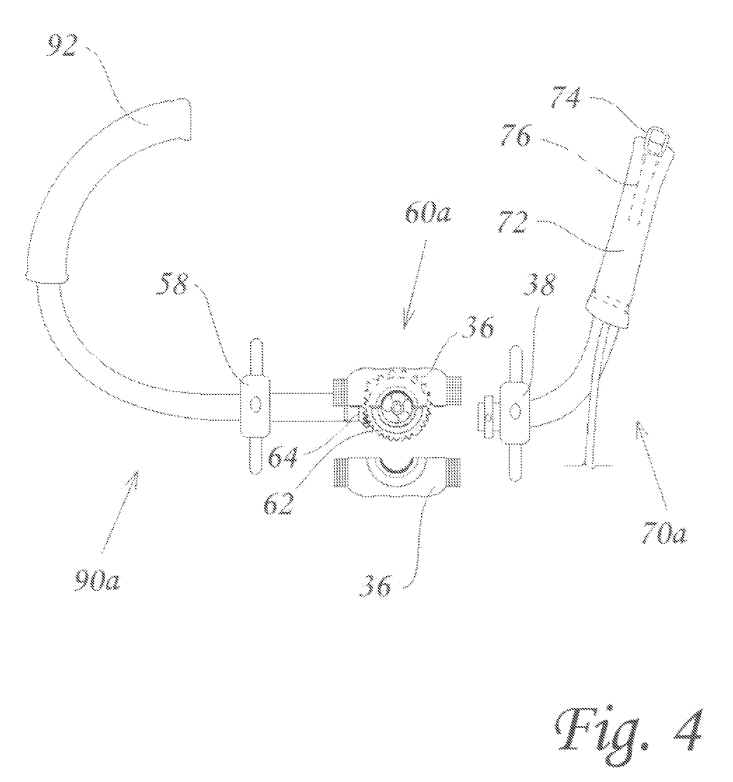

Referring again to FIG. 1a-FIG. 3 and also to FIG. 1a, the operator 32 has means for applying a reverse hand grasp 54 known as a hook grasp on the second control grip, as shown in FIG. 3, for transposing the second control grip 92 arrangement of the forth arm 90a into a third control grip 94 arrangement of the forth arm 90a, as examined in FIG. 4. The forth arm 90a pivots and transposes the second control grip 92 arrangement into the third grip 94 arrangement through the axis of the first arm 30a away from the second arm 50a and the tool assembly 40a. It is important to note that the operator 32 will alternate the functional hand grasp 52, as demonstrated in FIG. 1a, with the reverse hand grasp 54 as a built in safety mechanism for substantially stopping the handheld lawn tool 10a movement before the second control arm and the third control arm adjustments are started. The transposing of the second control grip 92 into the third control grip 94 will rearrange the distal ends of the first and the second arms 30a and 50a in a first diagonal direction 122, as observed in FIG. 3, with the first 72 and the third 94 control grips diagonally centered in the forward transport path 112 of the first and the second functional hand grasps 34 and 54 of the operator 32. Again, the operator 32 is capable of applying the first functional hand grasp 34 on the first control grip 72 and the trigger control 76 with the second functional hand grasp 52 on the third control grip 94 and the cutting tool 42 circumferentially fixed in the vertical cutting circle 104 substantially along the ground level in a second forward transport path 114 in which the operator 32 transports the handheld lawn tool 10a along the first forward transport path 112.

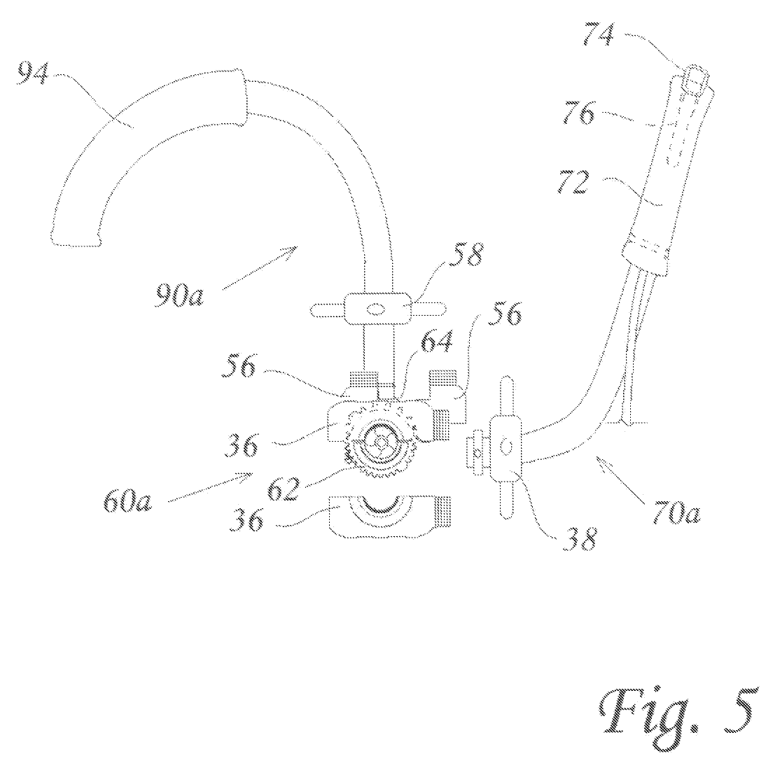

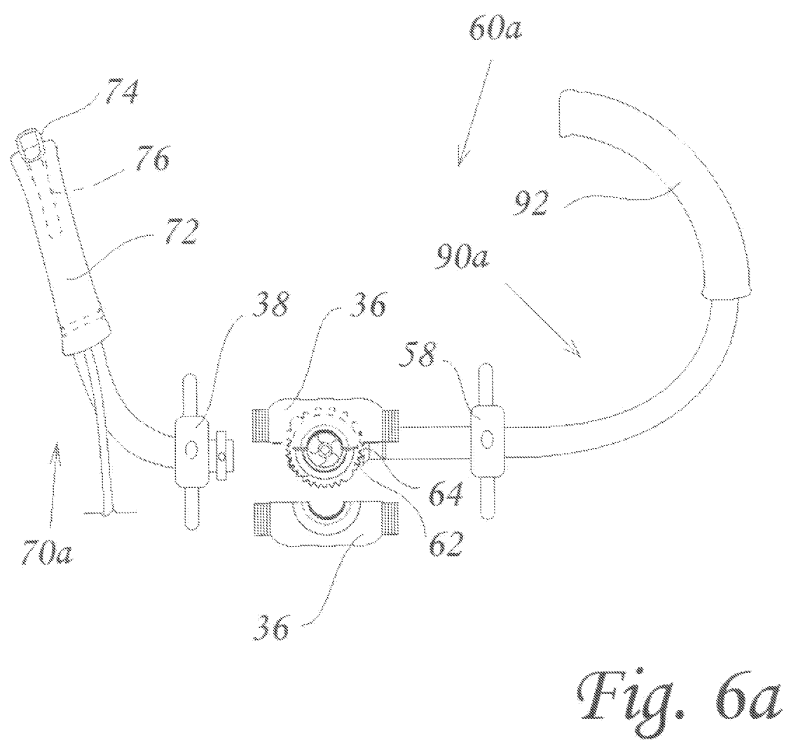

Referring to FIG. 1a-FIG. 5, an alternative gearbox 60a assembly of the invention, as shown in FIG. 4 has a first gear 62 longitudinally mitered at a front end of the first arm 30a and a second gear 64 laterally mitered at a proximal end of the third arm 70a for the first gear 62 and the second gear 64 for interconnecting the arms 30a, 50a, 70a and 90a near the balancing point 14 of the boom 12. The first gear 62 is pivotally linked to the first arm 30a for reversing the second gear 64 into an upright arrangement so that the first arm 30a and the third arm 70a remain integrally upright while boosting the pivotal forces of the second and the forth arms 50a and 90a, but the gearbox 60a is unnecessary when the forth arm 90a pivots in the same direction as the second arm 50a. The first control grip 72 and the second control grip 92 arrangements, as shown in FIG. 4, align and adjust congruently with the first gear 62 and the second gear 64 adjustments. Therefore, the second gear 64 may have a gear cam lock or the like gear lock, but it is inessential, for stopping the third arm 70a from pivoting into the second arm 50a region of the boom 12. Furthermore, the third control grip 94, as viewed in FIG. 5, is functionally hand grasped by the operator 32 about one inch lower than the second control grip 92 which automatically raises the vertical cutting circle 104 of the cutting tool 42 to an appropriate height at about ground level with respect to the prior arrangement of the horizontal cutting circle 102 of the cutting tool 42 being fixed at about two inches above ground level. The second gear 64 can be interchanged to either side of the boom 12 or the second gear can be parallel linked to a third gear.

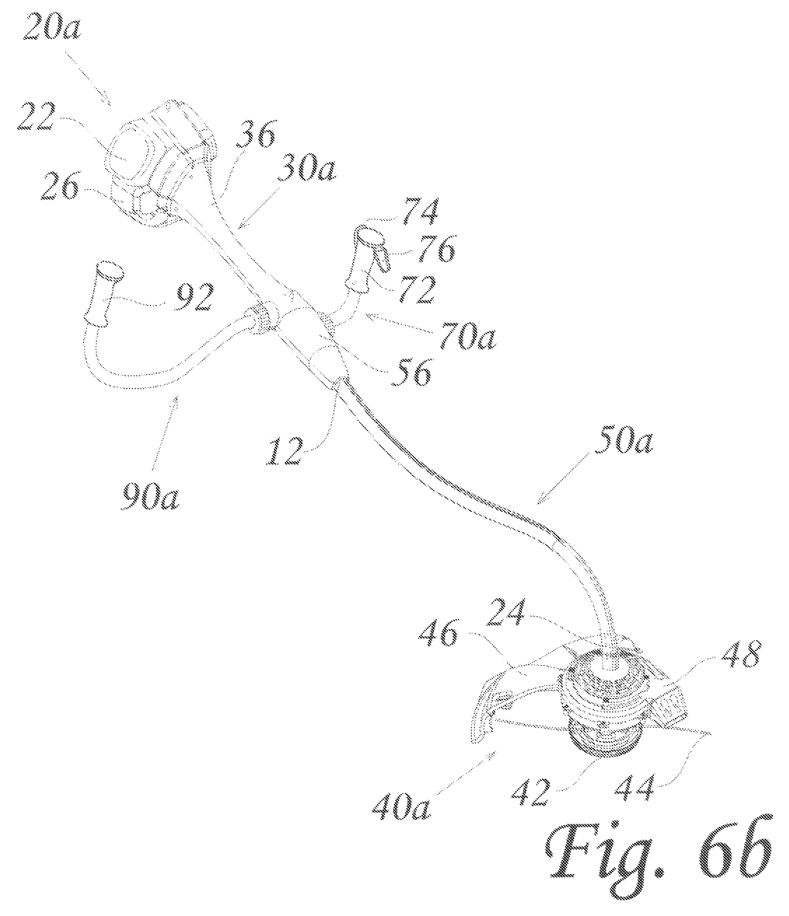

Referring to FIG. 6a-FIG. 6b and to FIG. 3, the first arm 30a of the handheld lawn tool 10a has means for interchanging on an opposite side of the boom 12 in which the first functional hand grasp 34 of the operator 32 is arranged on the second control grip 92 and the second functional hand grasp 52 of the operator 32 is arranged on the first control grip 72 in the horizontal cutting circle 102 arrangement of the cutting tool 42. The boom 12 is pivotally arranged on the first forward transport path 112 with the operator 32 capable of negative transposing the second control grip 92 into the third control grip 94 in which the vertical cutting circle 104 is arranged in a third forward transport path 116 about mirroring the second forward transport path 114 on the opposite side of the first forward transport path 112 of the operator 32 and in an opposite direction of the vertical cutting circle 104 of the cutting tool 42. The boom 12 diagonal arrangements 122 and 124 will be substantially balanced in front of the operator 32 with the tool assembly 40a arranged in low profile near the ground level.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A handheld lawn tool comprising:
a motor assembly including a source of power horizontally fixed on a first arm for transferring energy to a motor, the motor operatively transferring the energy axially down a drive shaft within at least a second arm to a pivotally fixed arrangement of a tool assembly for lawn grooming, the tool assembly including a blower for assisting a substantial leading radian portion of a cutting tool, wherein a trailing radian portion of the cutting tool is covered by a cutting guard substantially in front of an operator;
a front distal end of the second arm mounted to the tool assembly and a rear distal end of the second arm mounted to the first arm for forming a longitudinal arrangement of a boom;
a first bracket fixed to the first arm and a second bracket fixed to the second arm;
a third arm having a proximal end horizontally fixed to the first bracket in about pivotal alignment of a forth arm, the forth arm fixed at a proximal end to the second bracket for a substantial lateral arrangement of the boom;
a first control grip horizontally fixed over a distal end of the third arm, the first control grip including an on/off switch pivotally arranged for activating and deactivating the motor and a trigger control pivotally arranged on the first control grip for activating and deactivating the cutting tool;
an operator having means for applying a functionally hand grasp on the first control grip in an inoperative arrangement of the cutting tool, the operator having means for applying a functional grip on the trigger control and the first control grip in an operative arrangement of the cutting tool;
a second control grip fixed over a distal end of the forth arm in about lateral alignment of the first control grip for a lateral arrangement of the boom, the operator having means for applying a second functional hand grasp on the second control grip in a first forward transport path of the boom with the cutting tool circumferentially locked in the horizontal cutting circle of the cutting tool of lateral pivot motion about two inches above the ground level in front of the operator;
a reverse hand grasp of the operator is applied on the second control grip for transposing the second control grip arrangement into a third control grip arrangement, the forth arm pivots and transposes the second control grip arrangement into the third grip arrangement through the axis of the first arm away from the second arm and the tool assembly, the transposing of the second control grip into the third control grip rearranges the distal ends of the first and the second arms in a first diagonal direction with the third and the forth arms diagonally rearranged for the first and the second functional hand grasps of the operator, the operator having means for applying the first functional hand grasp on the first control grip and the trigger control with the second functional hand grasp on the third control grip with the cutting tool circumferentially locked in the vertical cutting circle substantially along the ground level in the second forward transport path in which the operator transports the handheld lawn tool along the first forward transport path;
the balancing point of the boom transposing between the first forward transport path of the horizontal cutting circle of the cutting circle and the second forward transport path of the abutting vertical cutting circle of the cutting tool;

2. A handheld lawn tool of claim 1, wherein: the first arm having means for interchanging on an opposite side of the boom in which the first functional hand grasp of the operator arranged on the second control grip and the second functional hand grasp of the operator arranged on the first control grip in the horizontal cutting circle arrangement of the cutting circle, the operator having means for negative transposing the second control grip into the third control grip in which the vertical cutting circle arranged in a third forward transport path mirroring the second forward transport path in an opposite direction of the vertical cutting circle of the cutting tool; and

3. A handheld lawn tool of claim 1, wherein: the first bracket having means for at least a first gear longitudinally arranged within the first bracket, the first gear cylindrically connected to the boom, wherein the proximal end of the boom having means for at least a second gear laterally arranged within the second bracket with the second gear fixed to the third arm and interconnected to the first gear.
